(19) United States
(12) Patent Application Publication
(10) Pub. No.: US 2006/0134953 A1
(43) Pub. Date: Jun. 22, 2006

(54) Electronic module latching mechanism

(75) Inventors: Carl D. Williams, Colorado Springs, CO (US); Jeffrey D. Wilke, Palmer Lake, CO (US)

Correspondence Address: PATTON BOGGS, 1660 LINCOLN ST, SUITE 2050, DENVER, CO, 80264, US

(73) Assignee: Adaptec, Inc., Milpitas, CA (US)

(21) Appl. No.: 11/305,494

(22) Filed: Dec. 15, 2005

Related U.S. Application Data
(60) Provisional application No. 60/639,890, filed on Dec. 22, 2004.

(51) Int. Cl. H01R 13/62

(52) U.S. Cl. 439/157

(57) ABSTRACT

An electronic module securing assembly includes a cam lever and a latch lever. The cam lever cams the electronic module connectors in and out of their sockets. The latch clicks into a catch to secure the module in its enclosure. The latch and cam levers can be operated by the user's thumb in one motion. The latch and cam levers can be made narrow to maximize the usable space on the electronic module.

### CROSS-REFERENCE TO RELATED APPLICATIONS

This Application is a Non-Provisional Application of U.S. Provisional (35 USC 119(e)) Application No. 60/639890 filed on Dec. 22, 2004 and claims benefit thereto.

### FIELD OF THE INVENTION

The invention relates to the field of cabinets and racks for supporting and/or enclosing electronics equipment, and, in particular, a mechanism for securing an electronics module in a cabinet.

### BACKGROUND OF THE INVENTION

In the electronics industry, electronic equipment is typically mounted in enclosures or cabinets to facilitate installation, interfacing with related equipment, and to facilitate access by technicians for servicing and repair. Such cabinets, enclosures, or racks, as they commonly are referred to in the art, generally include shelves, runners, or other supports for holding one or more electronics assemblies or modules in one or more module bays. The enclosures or cabinets provide support, protection, and often, electronic shielding, for the electronics modules to be enclosed in the enclosure. Generally, they also provide openings for ventilation, cable access, control panels, displays, and other purposes. Often, the general physical parameters of such cabinets, bays, and modules are defined by an electrical standard. Generally, the cabinets are constructed so many different kinds of modules, each dedicated to a particular function, may be enclosed. For example, a server computer may include one or more processing modules, one or more data storage modules, one or more display modules, and one or more input and/or output modules. The modules maybe mixed and matched to provide many different computer architectures to meet the needs of a variety of customers. Generally, the electronics modules are interchangeable. For example, if a module fails, it can be removed and replaced with another identical or similar module while it is being repaired.

The cabinets and electronics modules must be constructed so that the modules are held securely in the cabinets. If a memory module, for example, could be easily dislodged, large amounts of data could be lost if it were accidentally moved so that one or more of its electrical connectors were disconnected, even for a short time. At the same time, it is essential that a module can be easily removed, so that repairs and modifications can be made quickly. In addition, when electronics modules are inserted, pins, sockets, and other similar sliding electrical connections must accurately and firmly mate. If there are many such sliding electrical connections to be made, this can require considerable force. Usually, in the prior art, these conflicting requirements were met by constructing modules that could be slid into cabinets easily on metal shelves or runners, pressed hard to firmly connect the sliding electrical connections, and then fastened securely with screws. Screws require tools for inserting or removing a module, and, if a screwdriver has been misplaced, quick changes become difficult. Thus, tool-less devices and methods for securing electronics modules have been devised. Such tool-less fasteners include flexible pins or flanges that snap into a hole. These have an advantage in that the “snap” into the hole tells the person inserting the module that the connection has been made. However, such snap-in fasteners often create problems if tolerances are not closely maintained, such as snaps that do not mate with their holes, or snaps which position the module in a way that electrical connections are not made properly. The sudden and hard force required to connect modules with snap-in fasteners may also bend electrical pins.

One solution to the above problems is the cam fastener. The cam fastener comprises a cam bearing pin, a cam, and cam lever. The cam is generally formed in the cam lever, and the lever provides leverage to operate the cam. The cam is shaped such that when the cam lever is pushed in one direction, the cam action pushes the module into the module bay and forces the pins or other sliding electrical connectors into their sockets, and when the cam lever is pushed in the opposite direction, the cam action pulls the pins or other sliding connectors out of their sockets and moves the module a small distance out of the module bay.

The primary advantage of the cam fastener, the leverage that permits the pins and sockets to be firm and smoothly mated, creates its own problem. A stray elbow that strikes the lever arm of a cam fastener can pull the module out and disengage the electrical connections resulting in data loss, system shutdown, and other similar significant problems. Thus, screws have been added to the cam fastener systems so they cannot be accidentally dislodged. This brought the module fastening system back full circle to the fastener system that required tools.

Thus, it would be highly desirable to have an electrical module securing system that has advantages of the cam fastener and at the same time can be secured without using a tool.

### BRIEF SUMMARY OF THE INVENTION

The present invention overcomes the problems outlined above by providing an electronics module securing assembly including an integrated camming assembly and latching assembly. The camming assembly preferably includes a cam lever having a cam surface which acts against a cam bearing. Preferably, the cam lever is attached to the electronics module and the cam bearing is attached to the electronics cabinet. The latching assembly preferably includes a latch lever and hook and a catch member, which are constructed so that an audible sound is emitted as the latch latches. Preferably, the latch and the cam can be engaged and released with one hand, most preferably with a single finger or thumb. Preferably, the latch is released by pressing the latch lever with a thumb, and as the latch lever is rotated downward, the thumb engages the cam lever and cams the module out of the cabinet.

The invention provides an electronic housing assembly comprising: an electronic cabinet having an electronic bay and an electronic module adapted to fit in the electronic bay; a cam bearing mounted on one of the electronic cabinet and the electronic module; and a camming and latching lever assembly mounted on the other of the electronic cabinet and the electronic module, the camming and latching lever assembly including a cam surface located to be engagable with the cam bearing when the electronic module is inserted into the electronic cabinet. Preferably, the cam bearing is mounted on the electronic cabinet, and the camming and latching lever assembly is mounted on the electronic module. Preferably, the camming and latching lever assembly is a single-action camming and latching lever assembly. Preferably, the camming and latching lever assembly includes a cam lever and a latch lever wherein the latch lever is operated in the same direction as the cam lever. Preferably, the direction is a circular or elliptical direction. Preferably, the direction is an essentially vertical direction. Preferably, the camming and latching lever assembly includes a latch assembly comprising a latch hook and a latch catch wherein the latch assembly is adapted to emit a sound when the latch hook engages the latch catch. Preferably, the camming and latching lever assembly includes a latch assembly comprising a latch hook and a latch spring, the latch spring located to force the latch hook against the latch catch. Preferably, there are two of the cam bearings and two of the camming and latching lever assemblies which provide a balanced force causing the module to move substantially parallel to the direction of the bay with essentially no motion in a direction perpendicular to the bay. Preferably, the camming and latching lever assembly comprises a cam lever and a latch lever wherein the cam lever and the latch lever pivot about a single pivot axis.

The invention also provides a method of releasing an electronic module from an electronic cabinet, the method comprising: moving a latch lever in a first direction to release a latch; and moving a cam lever in the first direction to cam the module out of the electronic cabinet. Preferably, the moving comprises moving in a circular or elliptical direction. Preferably, the latch lever includes a latch lever thumb plate and the cam lever includes a cam lever thumb plate wherein moving the latch lever and moving the cam lever comprises engaging both the latch lever thumb plate and the cam lever thumb plate with the same thumb. Preferably, the electronic module and electronic cabinet include a first latch lever, a second latch lever, a first cam lever and a second cam lever, and the method comprises operating the first latch lever and the first cam lever with one hand and operating the second latch lever and the second cam lever with the other hand. Preferably, moving the latch lever and moving the cam lever comprises pivoting the latch lever and the cam lever about the same pivot axis. Preferably, there are two of the cam levers located on the module and moving the cam lever comprises moving both of the cam levers to provide a balanced force causing the module to move substantially parallel to the direction of the bay with essentially no motion in a direction perpendicular to the bay. Preferably, moving the cam lever and moving the latch lever are performed in a single continuous motion.

In another aspect, the invention provides a method of inserting an electronic module into an electronic cabinet, the method comprising: moving a cam lever in a first direction to cam the module into the electronic cabinet; and permitting a latch hook to seat against a latch catch to latch the module into the electronic cabinet. Preferably, the permitting further comprises emitting an audible sound as the latch hook seats against the latch catch. Preferably, there are two of the cam levers located on the module, and moving the cam lever comprises moving both of the cam levers to provide a balanced force causing the module to move substantially parallel to the direction of the bay with essentially no motion in a direction perpendicular to the bay.

The invention not only provides a tool-less cam fastener, but also provides a fastener that provides an audible signal when the module and its electrical connectors are fully inserted. Numerous other features, objects, and advantages of the invention will become apparent from the following description when read in conjunction with the accompanying drawings.

### BRIEF DESCRIPTION OF THE DRAWINGS

FIG. 1 shows a rear view of an electronics cabinet according to the invention containing an electronics module according to the invention;

FIG. 2 shows an electronics module according to the invention;

FIG. 3 shows an exploded view of the electronics module securing assembly;

FIGS. 4 A through 4D illustrate the operation of the electronics module securing assembly according to the invention;

FIG. 5. shows a detail of the electronic module of FIG. 2 showing the securing assembly; and

FIG. 6. shows a close-up of the detail of FIG. 5, illustrating the latch portion of the securing assembly according to the invention.

### DETAILED DESCRIPTION OF THE INVENTION

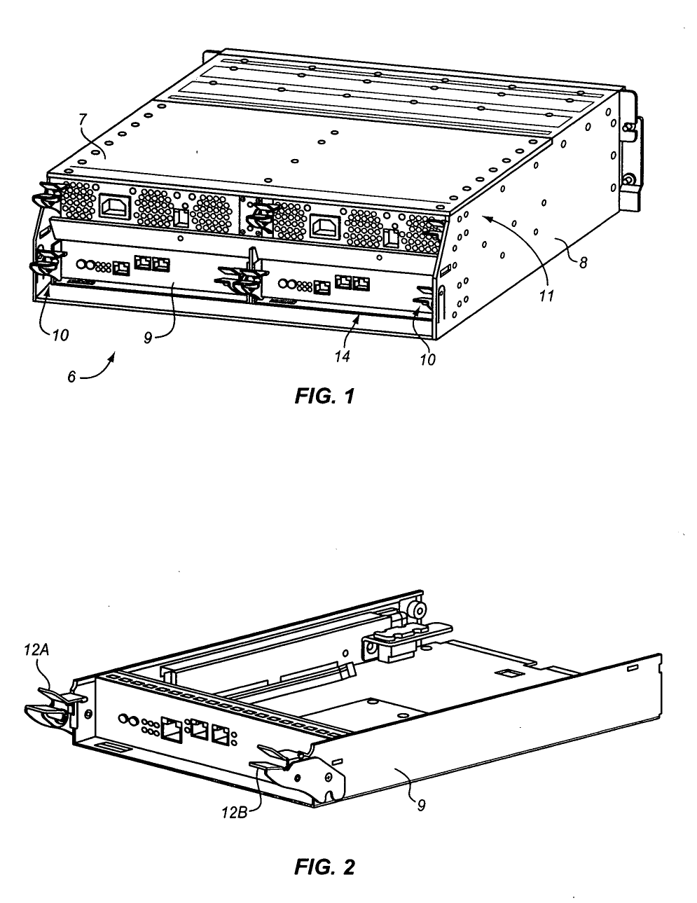

FIG. 1 shows a rear perspective view of a data storage enclosure or cabinet 8, an exemplary form of an electronics housing 6 according to the invention. Designs vary between enclosures. This particular enclosure shows a Power and Cooling Module 7 in the top bay 11 of enclosure 8 and an Input/Output (I/O) Module 9 in lower bay 14. An important aspect of the invention is the securing assemblies 10, which secure modules 7 and 9 in enclosure 8. As best shown in FIG. 4, the securing assemblies 10 each include a camming assembly 30 and a latching assembly 40. The camming assembly includes a cam lever 70 and a cam bearing 20. The latching assembly 40 includes a latch lever and a catch 50. The cam lever and latch lever are integrated into a camming and latching lever assembly, such as 12A. The camming and latching lever assembly is preferably attached to module 9, while the cam bearing 20 and catch 50 are preferably attached to enclosure 8. In data storage enclosures, the forces required to connect or mate the Power Supplies and I/O Modules to the enclosure midplane and to disconnect or unmate the Power Supplies and I/O Modules from the enclosure midplane are relatively large due to the large number of electronic connections. It is a feature of the invention that, in addition to providing a latching function to secure electronic modules 7 and 9 in enclosure 8, securing assemblies 10 provide mechanical leverage to assist in the mating and unmating.

FIG. 2 shows a typical I/O Module 9 removed from the enclosure. In this figure, the camming and latching lever assemblies 12A and 12B of this module are in the “closed” position. This is the position they are in when module 9 is installed in enclosure 8.

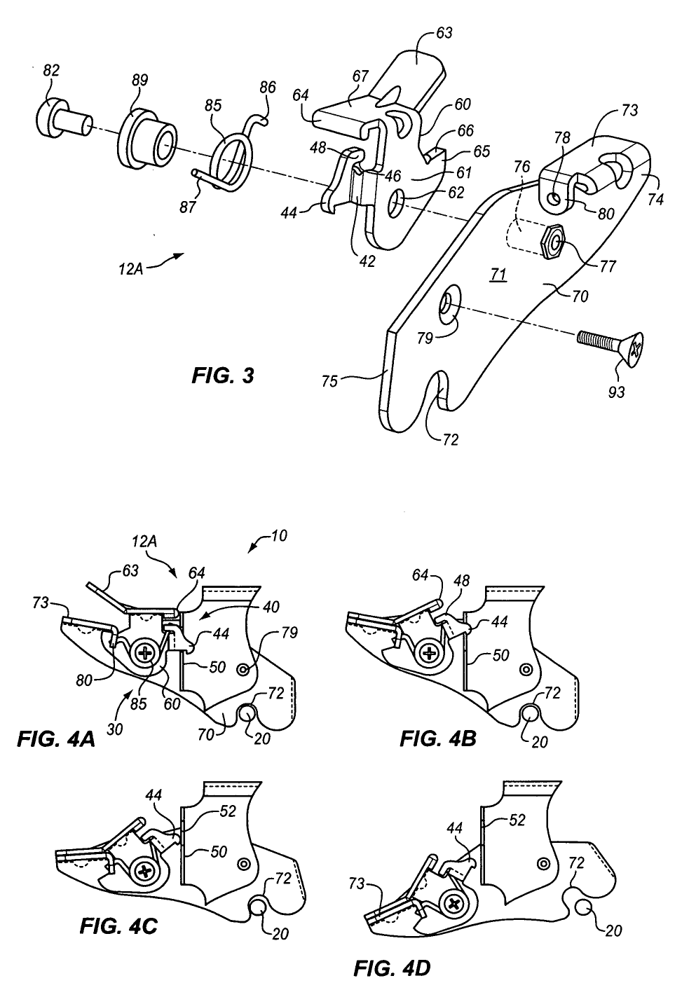

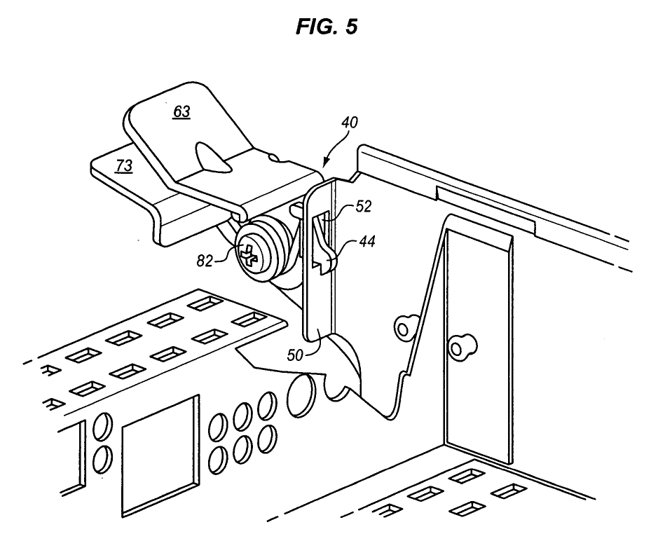

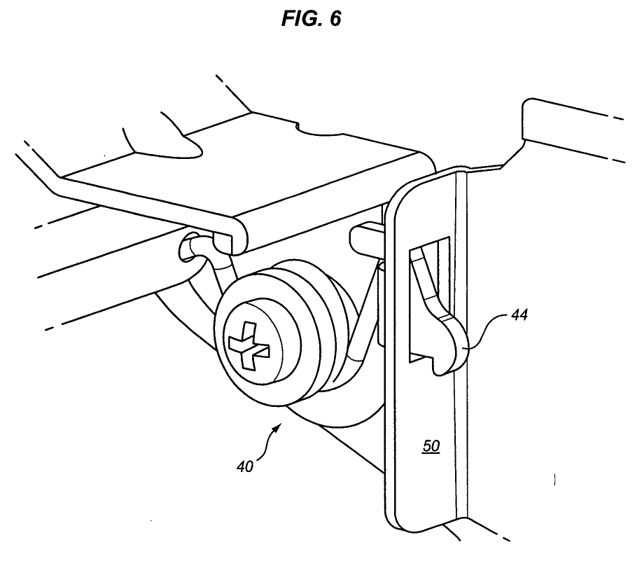

An exploded perspective view of camming and latching lever assembly 12A is shown in FIG. 3. Camming and latching lever assembly 12A comprises a latch lever 60, a cam lever 70, a spring 85, a washer 89, camming and latching lever assembly fastener 82, and locking pin 93. Latch lever 60 includes: latch body 61 having an opening 62 for receiving fastener 82, latch pressure plate 63 which is preferably a thumb plate, first stop arm 67 having a stop 64 at its distal end, second stop arm 65 having a stop surface 66, latch arm 42 having a latch bar 44, and a first spring anchor 48. Cam lever 70 includes: a cam lever body 71 having a proximal end 74 and a distal end 75, a cam surface 72, a cam lever pressure plate 73, which, like pressure plate 63 on the latch, is adapted to be pressed with a human thumb, a bearing member 76 having a bore 77 for receiving fastener 82, second spring anchor 80 having an opening 78 for receiving end 86 of spring 85, and a lock port 79 for receiving lock pin 93. The structure of camming and latching lever assembly 12B is a mirror image of the structure of assembly 12A.

In the preferred embodiment, latch bar 44 is a latch hook 44, fastener 82 and lock pin 93 are screws, and cam bearing 20 is a cam peg 20. Preferably, all parts are made of metal, such as aluminum or steel, but they also may be made of a suitable plastic.

The general functionality of the securing assembly design is illustrated in FIGS. 4A through 4D. In FIG. 4A, each securing assembly 10 is in the closed position. In FIG. 4B, the latch bar 44 has been raised; and in FIG. 4C, the cam member lever body 71 has rotated so that the proximal end 74 has moved downward and the distal end 75 has moved upward. FIG. 4D shows the securing assembly 10 in the “open” position. As can be seen in the figures, one end 86 of spring 85 engages spring anchor 80, and the other end 85 abuts the side 46 of spring anchor 48 holding it in place. It is perhaps easiest to understand the operation of the invention by reviewing the process of removing a module, following FIG. 4. The operator first presses thumb plate 63 of the latch mechanism (see FIG. 4A). This force overcomes the spring force and disengages the latch hook 44 from the catch 50. To prevent accidental removal, there are two camming and latching lever assemblies, 12A and 12B, on a typical module, such as 9 (FIG. 2), forcing the operator to use both hands to remove it. Once latch hook 44 is disengaged as shown in FIG. 4B, the operator continues pressing downward on the latch's thumb plate 63. This transfers the downward force onto thumb plate 73 of cam lever body 70. As securing assembly cam lever 70 begins to pivot as shown in FIG. 4C, it pushes against cam peg 20 of storage enclosure 8. The leverage against the cam bearing pegs overcomes the disconnection force of the module and midplane connectors assisting in pulling module 9 out of enclosure 8. The cam lever and cam profile 72 of the cam lever are designed such that as cam lever thumb plate 73 reaches its lowest point, the connectors are fully disengaged. Grasping the securing assemblies, the operator can now pull to remove module 9.

Module 9 is installed as follows, referring to FIGS. 4D through 4A. As module 9 is slid into the appropriate opening of enclosure 8, cam pegs 20 attached to the enclosure hit cam profile 72 of the camming and latching lever assemblies 12A and 12B. The operator lifts up on pressure plate 73 at the proximal end of lever 71 causing cam profile 72 to cam onto the cam bearing pegs 20. This gives the operator the necessary leverage to overcome the mating forces between the connectors, thus facilitating the insertion of the electrical connectors or the module into the mating connectors or the enclosure midplane. When the module is installed in the data storage enclosure, latch hook 44 in the latch assembly 40 hooks into mating latch member 50 of latch assembly 40, through slot-like latch opening 52, securing module 9. This prevents accidental opening of the camming and latching lever assemblies; thus accidental removal of a module during operation due to either shock and vibration of the data storage enclosure or accidental pressure on one of thumb plates 63. Hook 44 passes through slot 52 in catch 50 and spring 85 causes latch hook 44 to seat in latch catch 50 and stop 64 to strike catch 50 with some force so an audible click is heard. The camming and latching lever assemblies are now in the closed position as shown in FIG. 4A. If desired, a screw can be inserted through cabinet housing 8 into locking port 79 to lock simultaneously the cam levers and lock the module in place.

Securing assembly latching mechanism 40 of the invention is vertical and mounted to the outside of each module. If the latch is made from sheet metal, for example, the actual width of the latch is only the thickness of the sheet metal (the latch hook). The only additional width is what is required to operate the mechanism, such as finger grip space and the width of any spring mechanism. This can be minimized, even more than shown in the above embodiment if desired.

The securing assembly can be operated in a single action. The action includes pushing down on latch pressure plate 63 which disengages latch hook 44. As the operator continues the single downward pressing motion, the latch plate presses against cam lever pressure plate 73. The cam lever then cams the module out of the enclosure.

Since cam lever 70 moves in a vertical direction, the sweep of the cam leaver in front of the module bulkhead forces a “keep-out” zone for cables/connectors. The invention, however, is a minimal-width design, allowing the maximum usage of the module bulkhead. A feature of the invention is that the camming lever is integrated with the latching lever such that both pivot about a single pivot axis defined by pin 82.

A related feature of the invention is that the overall design holds an electronic module firmly, the module can be easily removed and replaced, and at the same time the securing mechanism can be made very narrow, i.e., 1.25 inches or less in width, more preferably in a range of from 0.25 inches to 1.0 inches, and most preferably about 0.75 inches.

Cam lever 70 and cam surface 72 are designed so significant leverage is obtained. The leverage advantage may vary depending on the available space within the electronic cabinet and other parameters. Preferably, the leverage is in the range of from about 3 to 1 to about 8 to 1. Most preferably, cam lever thumb plate 73 moves about 1.25 inches while cam surface 72 moves about 0.75 inches. Thus, the most preferable leverage advantage is about 5 to 1.

According to the invention, securing assembly 10 is a single action device in that both the latch and the camming mechanism can be operated with one hand, and preferably operated in a single direction, and most preferably with a single continuous motion. Preferably, the single direction is a circular or elliptical direction.

The embodiment described uses two securing assembly mechanisms, each with latch and cam mechanisms. It is possible to use one latching mechanism and two cams. The dual cams create a balanced force during installation and removal of a module, but the single latch will still secure a module in an enclosure during operation and shock and vibration. The term “a balanced force” means that the module is forced equally at two positions which are located so that the module moves in substantially a direction parallel to the module bay direction, with essentially no motion perpendicular to this direction. Herein, the module bay direction is along the depth of the bay, i.e., the direction the module moves into the bay.

There has been described novel electronic module securing assemblies and methods of securing an electronic module to an electronic enclosure. It should be understood that the particular embodiments shown in the drawings and described within this specification are for purposes of example and should not be construed to limit the invention, which will be described in the claims below. For example, it is possible to put the cam peg on the electronic module and the camming and latching lever assembly on the enclosure. Other latching mechanisms and other leveraging mechanisms may be used. Further, it is evident that those skilled in the art may now make numerous uses and modifications of the specific embodiments described without departing from the inventive concepts. The various elements maybe arranged differently, and the various processes of the method maybe performed in a different order. It is also evident that equivalent structures and processes maybe substituted for the various structures and processes described. Consequently, the invention is to be construed as embracing each and every novel feature and novel combination of features present in and/or possessed by the electronic enclosure, the electronic module, the electronic module securing assembly, and methods of operating the foregoing as described.

What is claimed as new and desired to be protected by Letters Patent of the United States is:

1. An electronic housing assembly comprising:
an electronic cabinet having an electronic bay and an electronic module adapted to fit in said electronic bay;
a cam bearing mounted on one of said electronic cabinet and said electronic module; and
a camming and latching lever assembly mounted on the other of said electronic cabinet and said electronic module, said camming and latching lever assembly including a cam surface located to be engagable with said cam bearing when said electronic module is inserted into said electronic cabinet.

2. An electronic housing assembly as in claim 1 wherein said cam bearing is mounted on said electronic cabinet and said camming and latching lever assembly is mounted on said electronic module.

3. An electronic housing assembly as in claim 1 wherein said camming and latching lever assembly is a single action camming and latching lever assembly.

4. An electronic housing assembly as in claim 3 wherein said camming and latching lever assembly includes a cam lever and a latch lever, and wherein said latch lever is operated in the same direction as said cam lever.

5. An electronic housing assembly as in claim 4 wherein said direction is a circular or elliptical direction.

6. An electronic housing assembly as in claim 4 wherein said direction is a vertical direction.

7. An electronic housing assembly as in claim 1 wherein said camming and latching lever assembly includes a latch assembly comprising a latch hook and a latch catch, and wherein said latch assembly is adapted to emit a sound when said latch hook engages said latch catch.

8. An electronic housing assembly as in claim 1 wherein said camming and latching lever assembly includes a latch assembly comprising a latch hook and a latch spring, said latch spring located to force said latch hook against said latch catch.

9. An electronic housing assembly as in claim 1 wherein there are two of said cam bearings and two of said camming and latching lever assemblies which provide a balanced force causing said module to move substantially parallel to the direction of said bay with essentially no motion in a direction perpendicular to said bay.

10. An electronic housing assembly as in claim 1 wherein said camming and latching lever assembly comprises a cam lever and a latch lever and wherein said cam lever and said latch lever pivot about a single pivot axis.

11. A method of releasing an electronic module from an electronic cabinet, said method comprising:
moving a latch lever in a first direction to release a latch; and
moving a cam lever in said first direction to cam said module out of said electronic cabinet.

12. A method as in claim 11 wherein said moving comprises moving in a circular or elliptical direction.

13. A method as in claim 11 wherein said latch lever includes a latch lever thumb plate and said cam lever includes a cam lever thumb plate, and wherein said moving said latch lever and moving said cam lever comprises engaging both said latch lever thumb plate and said cam lever thumb plate with the same thumb.

14. A method as in claim 11 wherein said electronic module and electronic cabinet include a first said latch lever, a second said latch lever, a first said cam lever, and a second said cam lever, and said method comprises operating said first latch lever and said first cam lever with one hand and operating said second latch lever and said second cam lever with the other hand.

15. A method as in claim 11 wherein said moving said latch lever and said moving said cam lever comprises pivoting said latch lever and said cam lever about the same pivot axis.

16. A method as in claim 11 wherein there are two of said cam levers located on said module and said moving said cam lever comprises moving both of said cam levers to provide a balanced force causing said module to move substantially parallel to the direction of said bay with essentially no motion in a direction perpendicular to said bay.

17. A method as in claim 11 wherein said moving said cam lever and said moving said latch lever are performed in a single continuous motion.

18. A method of inserting an electronic module into an electronic cabinet, said method comprising:
moving a cam lever in a first direction to cam said module into said electronic cabinet; and
permitting a latch hook to seat against a latch catch to latch said module into said electronic cabinet.

19. A method as in claim 18 wherein said permitting further comprises emitting an audible sound as said latch hook seats against said latch catch.

20. A method as in claim 18 wherein there are two of said cam levers located on said module and said moving said cam lever comprises moving both of said cam levers to provide a balanced force causing said module to move substantially parallel to the direction of said bay with essentially no motion in a direction perpendicular to said bay.
